(19) United States
(12) Patent Application Publication
(10) Pub. No.: US 2014/0153354 A1
(43) Pub. Date: Jun. 5, 2014

(54) ARRANGEMENT AND METHOD FOR HANDLING CEMENT MORTAR

(71) Applicant: Göran Palmers, Goteborg (SE)

(72) Inventor: Göran Palmers, Goteborg (SE)

(73) Assignee: MINIDEA AB, Goteborg (SE)

(21) Appl. No.: 14/232,884

(22) PCT Filed: Jul. 13, 2012
(86) PCT No.: PCT/SE2012/050836

§ 371 Date: Jan. 14, 2014

(30) Foreign Application Priority Data
Jul. 15, 2011 (SE) 1150702-7

(51) Int. Cl. B28C 7/04; B28C 9/04

(52) U.S. Cl. CPC B28C 7/0413; B28C 9/04
USPC 366/8; 366/19

(57) ABSTRACT

Mixing device for handling of a cement product, comprising a carryable mixing unit for mixing of powder and water, a feeder unit for feeding in powder to the mixing unit and a flexible tube packet connecting the mixing unit to the feeder unit, wherein the mixing unit comprises a receiver part for powder, dosing equipment for powder, dosing equipment for water, a mixer for mixing of powder and water and an outlet pump for feeding out the finished mixed cement product. An advantage of the invention is that the mixing unit can be carried by one person, which simplifies the handling of the mixing unit. A further advantage is that dosing and mixing of a cement product takes place automatically. The mixing of the cement product thus may take place continually.

### FIELD OF THE INVENTION

The present invention relates to a carryable device for the handling of cement products as well as a method for handling cement products.

### PRIOR ART

When laying floors in bathrooms, large amounts of cement products are consumed in the form of smoothing compounds for making the floor even and creating a suitable substrate for the surface layer of the floor. Especially in blocks of flats and when building new houses or making extensive renovations many floors must be treated with smoothing compounds. This demands that large amounts of smoothing compound are transported to the places to be treated therewith. The transport of smoothing compounds can be performed in different ways, depending on the amount of smoothing compound needed and the building in which the treatment is to take place.

For great amounts of smoothing compound the use of pumping trucks is known, which have a great capacity and are therefore used when handling larger volumes of smoothing compound, 3000 kg or more per occasion. This smoothing compound must be used relatively soon after the compound is mixed, before the mixture starts to harden. Such a pumping truck pumps up smoothing compound that is delivered ready-mixed by concrete trucks. Apart from the fact that such a solution is suitable only for large volumes used at the same occasion, e.g. in new production or renovation of large floor areas, it also entails great losses, partly because of the long tubes, partly because it is difficult to calculate and mix the exact amount needed. There will thus often be residues of smoothing compound.

For somewhat smaller amounts there are also smaller, freestanding pumps in the market, which can be used from about 1000 kg upwards per occasion. The handling of such freestanding pumps demands several persons, and they are difficult to clean, and thus they are not suitable for smaller amounts of smoothing compound.

U.S. Pat. No. 4,117,547 describes a transportable mixing unit mounted on a wheeled frame. This mixing unit is intended for mixing intermediate amounts of cement in the place where the mixture is to be used, and it is provided with a mixer and an outlet pump that transports the finished mixed cement product out through a tube. The mixing unit also comprises a receiver part for powder, a feeder screw for powder and a water inlet. The mixer part and the outlet pump are operated by separate motors.

For smaller amounts of smoothing compound, less than 500 kg per occasion, freestanding pumps are thus not a useful alternative. Instead, the daily handling of smaller amounts of smoothing compound is performed by handling bags of 25 kg of compound powder manually. Each bag often must be handled manually several times a day. Firstly, they are loaded on the truck in the morning to be driven to the building area, and then they must be unloaded and transported into the work area. In the work area, the bags are handled once more at the mixing. The mixing can be done either with an electrical handheld stirrer in buckets or in a concrete mixer, after which the mixture is filled in buckets. As the mixing is usually done in the place where the treatment with smoothing compound is to take place, the mixing gear and at least all the powder material must also be lifted to the place to be smoothed. Buildings with up to 4 floors often have no lift installed. It is thus a heavy and straining work to carry forth the material needed for smoothing.

When renovating bathroom floors, for example, the total need of smoothing compound may be comparatively large, while the need of smoothing compound for each bathroom floor is comparatively small. For instance, one bathroom floor may need 200 to 300 kg of smoothing compound, which must be laid out and smoothed before the work on the next bathroom floor can be started. The known solutions are thus not suitable when e.g. renovating smaller floors, where relatively small amounts of smoothing compound are needed at each occasion.

There is thus a need for a better handling of a smaller amount of cement product.

### DESCRIPTION OF THE INVENTION

A purpose of the invention is therefore to provide a carryable mixing unit for a cement product that permits simple and rational mixing of the cement product. Another purpose of the invention is to provide a mixing device for a cement product that permits simple and rational handling of a cement product. Another purpose of the invention is to provide a mixing device that permits continuous mixing of a cement product. Another purpose of the invention is to provide a carryable mixing unit that permits cleansing of the flexible tube for the cement product without loss of cement product. Another purpose of the invention is to provide a method that permits simple and rational handling of a cement product.

The solution of the problem according to the invention is described in the characterizing part of Claim 1 for the mixing unit, Claim 12 for the mixing device and Claim 14 for the method for mixing a cement product. The other Claims contain advantageous embodiments and developments of the mixing unit, the mixing device and the method for mixing a cement product.

With a carryable mixing unit for mixing a cement product, comprising a mixer for the mixing of powder and water and an outlet pump for letting the final mixed cement product out, the purpose of the invention is attained by the mixing unit comprising a receiver part for powder, dosing equipment for powder and dosing equipment for water.

With this first embodiment of the carryable mixing unit a mixing unit is provided, in which the mixing of powder and water takes place automatically and in a controlled way. The powder is transported in bulk through a flexible tube to the mixing unit, where it is dosed in the correct amount in the mixer. Simultaneously, other dosing equipment doses water in the mixer in proportion to the chosen amount of powder. The mixed cement product is then fed out to a user by an outlet device.

This mixing unit provides automatic dosing and mixing of a cement product. The mixing unit can be made relatively small and simple, as the powder is transported in bulk to the mixing unit, and it may thus be carried to the work area by one person. A carryable mixing unit thus can easily be moved from one place to another, which also entails that no long tubes are needed for transporting the final mixed cement product. The mixing unit thus needs not be able to handle very great amounts of powder or cement product at once, but rather the mixing of cement product may be done continually at the same rate as the cement product is needed. The mixing unit also permits mixing of a small amount of cement product, considerably less than one bag, which means that only the cement product that is needed needs to be mixed. The weight of the mixing unit is preferably less than 32 kg, more preferably less than 25 kg and most preferably less than 20 kg.

According to an advantageous development of the invention the mixing unit is controlled by an electronic control unit. Via an electronic control unit, the dosing of powder and water can be done even more precisely, which gives a cement product of better quality. It further becomes possible to set a predetermined amount of cement product to be mixed. The mixing device also becomes simpler to adapt to different types of powder, because the powder dosing and the water dosing can easily be adjusted to the chosen cement product. An electronic control unit also permits automatic cleaning of the mixing device, e.g. after it has been standing still for a certain time.

According to an advantageous development of the invention, the mixer and the outlet pump of the mixing unit are arranged concentrically along a common central axis, and they are advantageously operated individually by two different motors. This saves on weight, and the unit becomes simpler to maintain. In this way the mixer and the outlet pump may be run independently of one another, which guarantees that the cement mixture is always completely mixed before it is fed out from the outlet pump. When a mixing process starts, only the mixer can be run until the first mix is completely mixed. Then the outlet pump can be started to feed the finished mixture out, at the same time as the mixer can go on to mix more smoothing compound. When the mixing process is to be stopped, the mixer may be run with water only to clean the mixer until the mixer is clean, at which time the outlet pump can pump out the water.

The mixer is advantageously provided with a flexible housing, e.g. a housing made from rubber or plastics, and advantageously provided with an open mixer screw. This makes the mixer lighter and ascertains reliable mixing. An open mixer screw lets the cement mixture be mixed several times before it is fed out, and the mixing time may be chosen freely, as opposite to closed mixer screws, where the length of the mixer screw determines the amount of mixing. When an open mixer screw is used, the mixer housing is advantageously arranged with a certain inclination to the horizontal plane, where an angle of 30 to 45 degrees is suitable.

According to an advantageous development of the invention, the mixing unit comprises a scale to measure the amount of powder that is dosed. In this way the exactness of the powder dosing can be increased further.

According to an advantageous development of the invention the mixing unit comprises further dosing equipment that can dose additives to the mixer. In this way additives may also be mixed with the cement product automatically with great precision. Via the choice of dosing of additives different properties of the cement product can also be achieved with great precision.

According to an advantageous development of the invention, the mixing unit further comprises a flexible tube cleanser, intended to cleanse the flexible tube transporting the cement mixture from the outlet pump. The flexible tube cleanser is used when a mixing batch is completed. By using the flexible tube cleanser, all the cement mixture in the flexible tube can be used. This makes it easier to cleanse the flexible tube, and a lesser amount of contaminated waste water is produced. The flexible tube cleanser may either be driven forward by the pressure in the flexible tube or have an electric auxiliary motor driving the flexible tube cleanser forward.

With a mixing unit for handling a cement product, comprising a carryable mixing unit for mixing powder and water, the purpose of the invention is achieved by the mixing unit also comprising a feeder unit for feeding powder to the mixing unit and a flexible tube bundle that connects the mixing unit to the feeder unit.

With this first embodiment of the invention, a mixing device is achieved, in which the handling of powder occurs enclosed in the mixing device. The powder is transported and stored in bulk in one or more tanks in the feeder unit, which also comprises a powder transporter. The feeder unit transports the powder to the mixing unit through a flexible tube, which means no manual handling of the powder is necessary. The mixing unit comprises a receiving part which receives the powder and acts like a small intermediate storage room or a buffer for the powder before it is dosed to the mixing unit. The mixed cement product is fed out to a user by an outlet device.

With this mixing device, automatic dosing and mixing of a cement product are achieved. The mixing device can be made comparatively simple, as the powder is stored in bulk. The mixing device thus portions out the amount of powder needed to the mixing unit, which entails that the mixing of the cement product can be done continually at the same rate as the cement product is needed. The mixing unit also permits mixing of a small amount of cement product, considerably less than one bag, which means that only the amount of cement product that is needed needs to be mixed.

According to an advantageous development of the invention the mixing device is controlled by an electronic control unit. Via an electronic control unit, the dosing of powder and water can be done even more precisely, which gives a cement product of better quality. It further becomes possible to set a predetermined amount of cement product to be mixed. The mixing device also becomes simpler to adapt to different types of powder, because the powder dosing and the water dosing may easily be adjusted to the chosen cement product. An electronic control unit also permits automatic cleaning of the mixing device, e.g. after it has been standing still for a certain time.

According to a further advantageous development of the invention, the feeder unit comprises several tanks for powder. In this way it becomes possible to choose the type of cement product in a simple way. By using a valve that chooses a tank, the electronic control unit can control the choice of cement product automatically. The feeder unit also may comprise a return tank, which collects the dirty water produced when the mixing unit is cleaned. By placing the feeder unit on a wagon or cart, it can be easily moved for filling and/or emptying of a tank.

### SHORT DESCRIPTION OF THE DRAWINGS

The invention will be described more in detail in the following, with reference to the embodiments shown in the attached drawings, where:

FIG. 1 schematically shows a mixing unit according to the invention,

FIG. 2 schematically shows a mixing device according to the invention,

FIG. 3 schematically shows a feeder unit for a mixing device according to the invention,

FIG. 4 shows a mixing unit according to the invention,

FIG. 5 shows the mixing unit according to FIG. 4 in cross section,

FIG. 6 shows an open flexible tube cleanser according to the invention, and

FIG. 7 shows an active flexible tube cleanser according to the invention.

### WAYS OF PRACTISING THE INVENTION

The embodiments of the invention with further developments that are described in the following should be seen as examples only and are in no way limiting the extent of the protection covered by the Claims. The invention is mainly intended for a mixture of water with a powder that has cement as binding agent, a so-called cement product. The term “cement product” is thus used here as a definition of different types of smoothing compounds, plaster, sealants and other similar mixtures of powder and water. Further mixtures based on a powder with another binding agent, such as gypsum, lime or plastics, can also be used in the described mixing unit, mixing device and mixing method. In the example described smoothing compound is used as an example of a cement product.

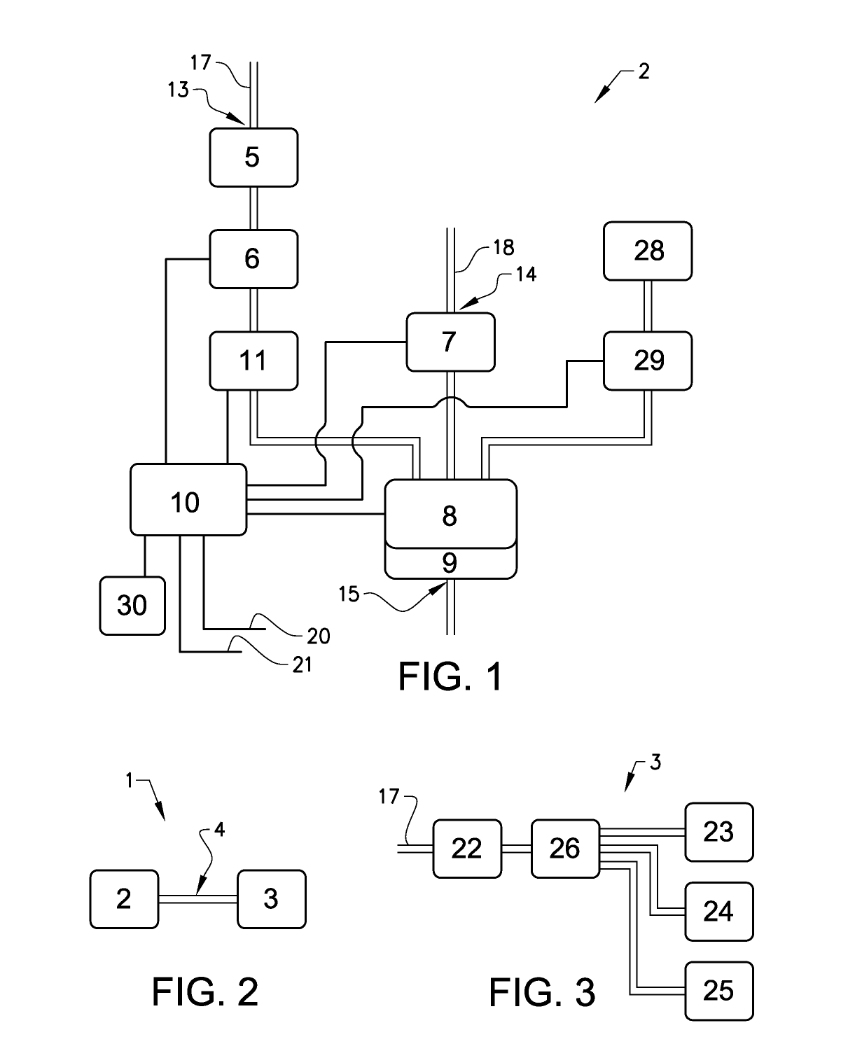

FIG. 1 schematically shows a mixing unit 2 according to the invention, comprising a mixer 8, intended to mix smoothing compound powder with water. The mixer is of a type that can mix compound powder and water in a continuous process and with a uniform quality. Such a type may be e.g. a screw mixer. In this way the mixer can mix smaller amounts of smoothing compound with a good and uniform quality, and it can also mix smoothing compound with continuous outlet, so that the smoothing compound can be spread out easily. The mixing unit also comprises an outlet pump 9 for feeding out the final mixed smoothing compound. The outlet pump may either be a separate pump or be integrated in the mixer, depending on the type of mixer.

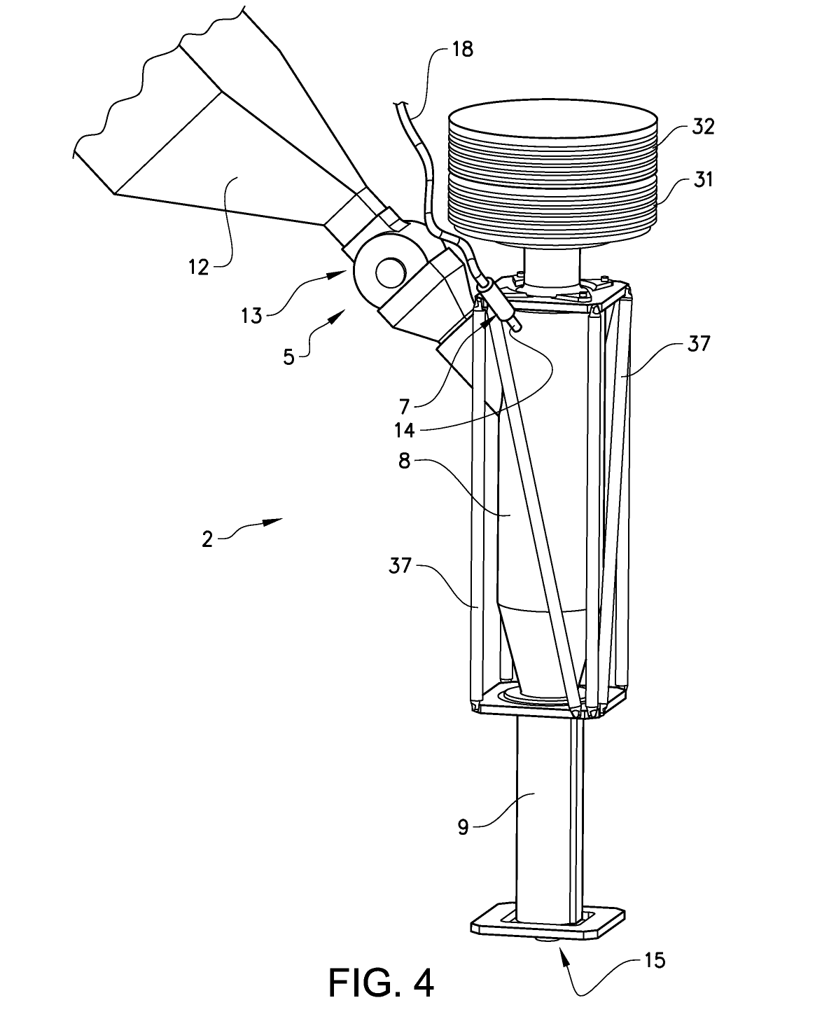

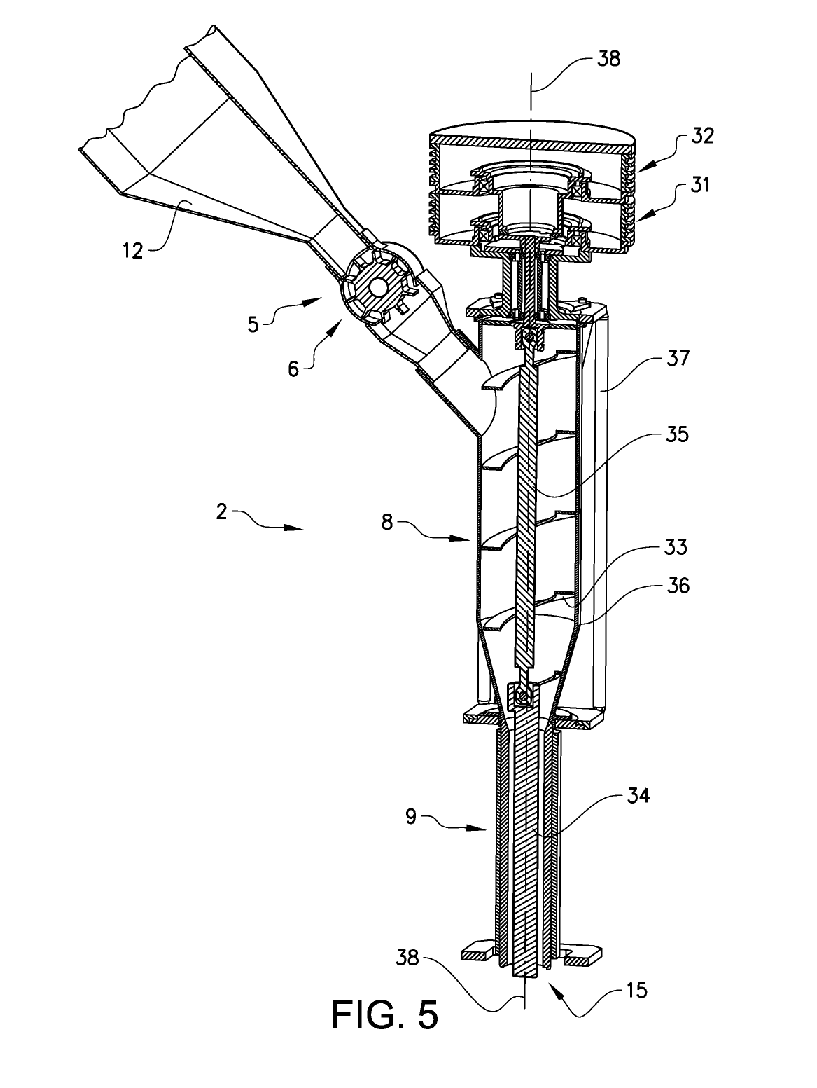

FIG. 4 shows an example of a mixing unit 2, and FIG. 5 shows the mixing unit 2 in cross section. The mixing unit 2 shown comprises a receiver part 5 comprising a powder doser 6 in the form of an adjustable feeder wheel, which feeds in a predetermined amount of powder per rotation. The receiver part 5 is provided with a powder inlet 13, where smoothing compound powder is introduced in the receiver part. To the powder inlet of the receiver part an optional powder container may be coupled, where the powder can be stored intermediately, so that the powder doser can dose the amount of powder needed to the mixer. In the example shown a funnel 12 is mounted at the powder inlet. The flexible powder tube feeding powder from the feeder unit to the mixer unit is connected to the powder container, comprising a flexible powder tube inlet and a filter. The powder container can thus receive powder from a feeder unit via a flexible powder tube. It is also possible to connect a separate funnel to the powder inlet, in which powder may be filled in bulk from bags. The mixer unit also comprises a water inlet 14, to which an adjustable valve may be coupled to dose the correct amount of water. The inlet from the receiver part and the water inlet open to the mixer housing 36, where the water inlet is arranged upstream from the connection of the receiver part to the mixer unit. In the mixer housing a mixer screw 33 is arranged, which is operated by a mixer motor 31. The mixer screw is advantageously an open mixer screw. When smoothing compound is to be mixed, powder is introduced from the receiver part and water from the water inlet to the mixer housing, where the mixer screw then mixes the smoothing compound until it is finished.

The mixing unit is advantageously arranged with an inclination to the horizontal plane, so that the central axis of the mixing unit has an angle to the horizontal plane which is advantageously 30 to 45 degrees. By arranging the mixing unit with an inclination and by using an open mixer screw it is guaranteed that the smoothing compound can be mixed sufficiently by being mixed several times before it can be fed out by the outlet pump. New smoothing compound powder and water is then supplied as needed to the mixing unit and mixed with the completely mixed smoothing compound. When the smoothing compound has been mixed a number of times it is ready and can be fed out by the outlet pump 9. Also in the outlet pump some mixing takes place, ascertaining a uniform and good quality of the smoothing compound. The mixer housing 36 is advantageously made from a somewhat flexible material, e.g. rubber or plastics, which reduces the weight of the mixer housing and also contributes to the smoothing compound releasing from the walls of the mixer housing. As the mixer housing is flexible, the mixer housing is stabilised with a number of struts 37.

The mixing unit is advantageously placed on a stand, ascertaining that the mixing unit is fixed and in the right position during the mixing process. The stand may be a separate stand or consist of foldable stand legs mounted on the mixing unit.

The mixer 8 and the outlet pump 9 are advantageously arranged concentrically along a common central axis 38, and they are advantageously operated individually by two different electrical motors 31, 32, the first motor 31 operating the mixer screw 33 and the second motor 32 operating the outlet screw 34 via a shaft 35 extending through the mixer. The motors are arranged at the upper part of the mixer unit. By using two different motors, the mixer and the outlet pump can be operated independently of one another, ascertaining that the mixture is ready before it is fed out by the outlet pump. At the same time, the outlet rate may be adapted to the desires of the operator without influencing the mixing quality. The feeding out of smoothing compound is done through the outlet 15 for smoothing compound, either directly to a bucket or similar or through a flexible tube permitting the smoothing compound to be directed to the desired position. The outlet for smoothing compound is advantageously provided with a suitable tube nipple.

When a mixing process starts, only the mixer is operated until the first mixture is ready. Then the outlet pump may be started to feed out the finished mixture at a desired rate, at the same time as the mixer may continue to mix more smoothing compound. When the mixing process is to be stopped the mixer may be run with water only to clean the mixer until the mixer is clean, when the outlet pump can pump the water out. The outlet pump is advantageously of the screw type. A flexible tube may be coupled to the outlet pump to feed the smoothing compound to a desired place. The outlet nozzle of the flexible tube has a valve to permit stopping the flow of smoothing compound and is advantageously provided with a wireless remote control, with which the feeding out of smoothing compound may be regulated. It is thus possible to start and stop the feeding out and also to control the outlet rate from the nozzle. It may also be possible to control the mixing with the remote control.

The mixing unit comprises a receiver part 5 with a powder inlet 13 for smoothing compound powder. Connected to the powder inlet of the receiver part is advantageously a funnel or other type of container serving as intermediate storage room or buffer for the smoothing compound powder. This intermediate storage room will also counter balance pressure variations that may occur when the smoothing compound powder is transported by a flexible tube from a tank to the receiver part. As the smoothing compound powder is advantageously transported by pressurized air through a flexible powder tube 17, the intermediate storage room contains an air outlet with a filter that lets out the excess pressurized air. In the receiver part 5 dosing equipment 6 is arranged, which doses the chosen amount of smoothing compound powder to the mixer. The dosing equipment may for example be a rotating feeder wheel or a feeder screw that feeds out a predetermined amount of powder per rotation. The dosing equipment doses the smoothing compound powder depending on the chosen amount of smoothing compound and whether a predetermined amount of smoothing compound is to be mixed or the mixing is to take place continuously. The mixing unit also comprises a dosing unit 7 for water with a water inlet 14, dosing water to the mixer in an amount adjusted to the chosen amount of smoothing compound powder. The dosing equipment for water advantageously comprises a continuously adjustable valve that can let through a predetermined amount of water. This may be equipped with a pressure sensor and a flow sensor to be able to dose the correct amount of water regardless of the water pressure. The dosing equipment may alternatively consist of a small water pump that pumps forth the desired amount of water from a separate water container. In this way a uniform quality of the mixed smoothing compound is achieved. The mixing unit may also comprise a scale 11, which can weigh the smoothing compound powder to give feedback to the dosing equipment 6. By weighing the smoothing compound powder a greater precision may be achieved, compared to simply measuring the volume of the smoothing compound powder. The scale is advantageously adapted to measure the weight of the smoothing compound powder continuously, e.g. by a form of collision scale.

The mixer is intended to mix smoothing compound powder and water to a homogenous smoothing compound. The mixer should be able both to mix predetermined amounts of smoothing compound and to mix smoothing compound continuously when larger amounts of smoothing compound are needed. The mixing unit may also comprise a third doser 29, intended to dose additives, e.g. antifreeze or adhesive, to the smoothing compound. The additive is stored in an additive tank 28. In this way desired properties of the smoothing compound can be provided in a simple and repeatable way.

The mixing unit is made sufficiently small and light to be carried by one person. The included components therefore are chosen in such a way that they do not weigh more than permissible for the complete mixer unit to be carried. The term “carryable” means that the mixing unit can be carried and handled by one person. One definition of the term “carryable” may be 32 kg, which according to international regulation is the greatest weight of aircraft luggage that may be handled by the aircraft staff. The weight of the mixing unit thus is advantageously less than 32 kg, more advantageously less than 25 kg and most advantageously less than 20 kg.

The mixing unit is suitably controlled by an electronic control unit 10, which is arranged to control and regulate the mixing unit. Especially the powder dosing equipment 6, the water dosing equipment 7 and the mixer 8 are controlled and/or read, and, when present, also the additive doser 29 and the scale 11. The control unit may also send control signals to the feeder unit, as described below. The control unit is further connected to an input device 30, where a user may choose the smoothing compound to be mixed and also input other data. The user can input the type of smoothing compound and the amount of smoothing compound and further make other choices, e.g. fine-tuning of the mixing proportions for a certain type of smoothing compound and whether the mixing is to take place continuously, in batches or only once. The input device advantageously has a display on which information can be given to the user. The input of data to the control unit may be done with buttons and/or with a menu system. The remote control on the output nozzle of the flexible tube is also wirelessly connected to the regulating unit. The electronic control unit may advantageously be integrated in the motor housing.

The mixing unit 2 is connected to a feeder unit 3 by a flexible tube bundle 4. The flexible tube bundle may consist of a number of flexible tubes and lines, advantageously assembled in a common housing. The flexible tube bundle comprises at least one flexible powder tube 17 to feed smoothing compound powder from the feeder unit to the intermediate container connected to the mixing unit or directly to the receiver part of the mixing unit. The flexible tube bundle may also comprise a flexible water tube 18 to feed water from the feeder unit to the mixing unit, a flexible return tube to return washing water to the feeder unit from the mixing unit, an electrical cable 20 to supply current between the feeder unit and the mixing unit and a control cable 21 to send control signals from the control unit to the feeder unit. Some of the flexible tubes or lines need not be part of the flexible tube bundle. The flexible water tube, e.g., does not need to receive water from the feeder unit if there are water supplies at other places in the building. The same applies to the electrical cable. The control signals between the control unit and the feeder unit may also be transferred wirelessly. The mixing unit may be supplied with current from another outlet, if one is available. Of course, the flexible return tube may also return the waste water to another collecting container, when there is one available.

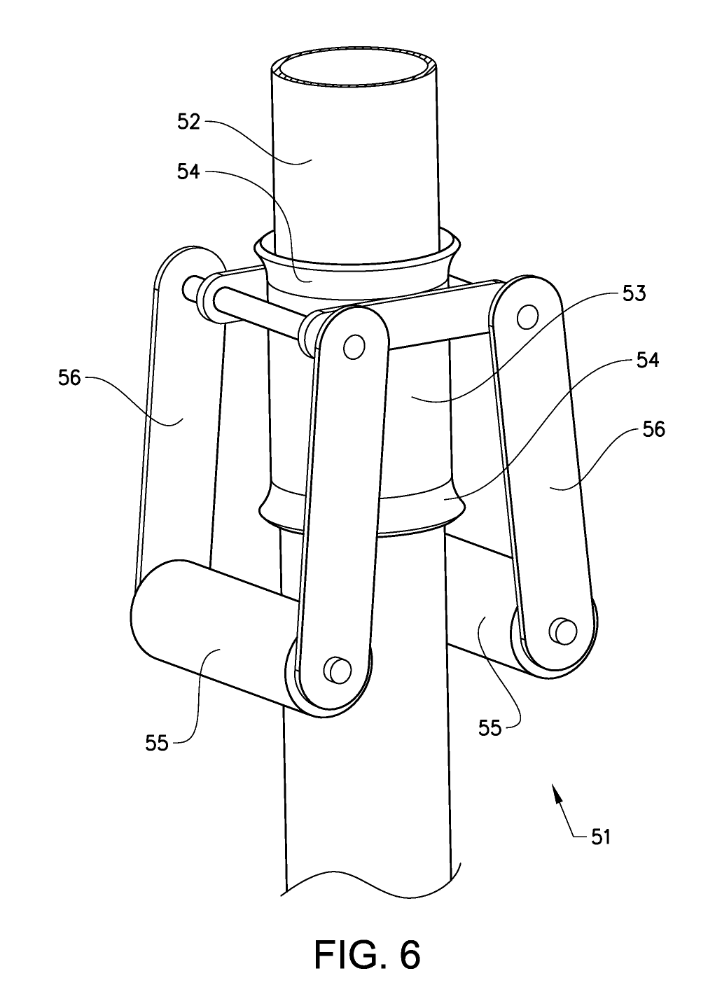

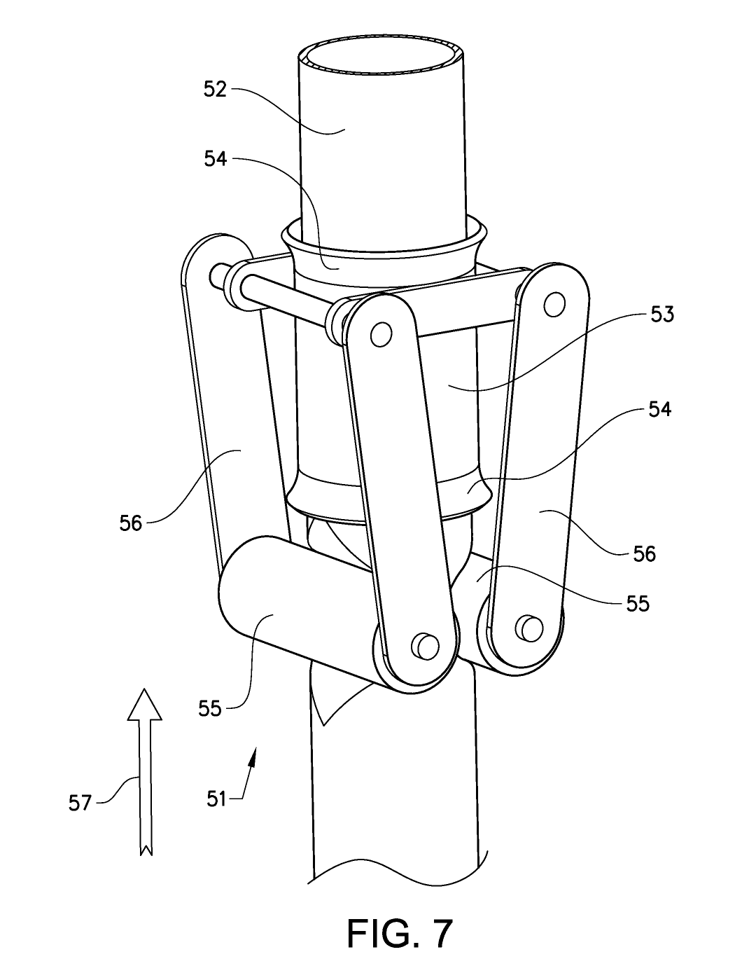

The mixing unit may also be provided with a flexible tube cleanser according to FIGS. 6 and 7. When smoothing compound is fed out from the mixing unit through a smoothing flexible compound tube 52, the flexible tube cleanser can be used to clean the flexible tube from the smoothing compound that has been fed out and to utilize all mixed smoothing compound. The flexible tube cleanser 51 consists of a main body in the form of a steering pipe 53 and two pressure rollers 55. The steering pipe 53 is provided with lead-in flanges 54 at both ends to simplify the mounting of the flexible tube cleanser on the flexible output tube 52. The steering pipe forces the pressure rollers to move alongside the flexible tube. The pressure rollers 55 are suspended in the steering pipe 53 by arms 56. The pressure rollers may have two positions, a first open position and a second active position. In the open position, shown in FIG. 6, the pressure rollers are biased apart, so that the distance between the pressure rollers corresponds to the diameter of the flexible tube. In this position, the flexible tube cleanser may easily be threaded onto the flexible tube without the pressure rollers bearing on the flexible tube. In the second active position, shown in FIG. 7, the pressure rollers are pressed toward one another by a resilient means (not shown), so that the flexible tube is pressed together by the pressure rollers. The flexible tube cleanser is advantageously threaded onto the flexible tube before a mixing process is started. The pressure rollers then are in the first open position, so that they do not bear on the flexible tube but move easily along the flexible tube. The flexible tube cleanser is threaded onto the flexible tube in such a way that the pressure rollers are directed toward the outlet nozzle of the mixer.

When a batch of smoothing compound is finished, e.g. when the user does not need more smoothing compound than what is left in the flexible tube, and the flexible tube is to be cleansed, the resilient means is loosened, so that the pressure rollers assume the active position with the pressure rollers as close as possible to the smoothing compound outlet 15, so that the pressure rollers press the flexible tube together. With assistance from a cleansing fluid, e.g. water, fed into the flexible tube from the outlet pump under pressure, the flexible tube cleanser is driven forth along the flexible tube by the water pressure, entailing the smoothing compound residues to be fed out of the flexible tube when the flexible tube cleanser moves forward along the flexible tube. The feeding direction of the flexible tube cleanser is shown by the arrow 57. Simultaneously the flexible tube is cleansed from smoothing compound residues at the inside of the flexible tube. When the flexible tube cleanser has arrived at the outlet nozzle of the flexible tube, the flexible tube cleanser is set to the open position, so that the cleansing fluid is let out, or, alternatively, the cleansing fluid is returned to the mixing unit and used to rinse also the mixer. If needed the procedure with the flexible tube cleanser may be repeated to clean the flexible tube further.

The flexible tube cleanser described above is intended to be driven forth along the flexible tube by the pressure created in the flexible tube by the outlet pump. It is also possible to provide the flexible tube cleanser with an electrical motor to drive the flexible tube cleanser forth along the flexible tube, wherein the motor drives one of or both the pressure rollers to rotate them. In this way the flexible tube cleanser may be used to empty the flexible tube without need of a water pressure acting on the pressure rollers. The motor can either be operated by a battery or be connected to the electrical mains by a cable. It is also possible to design the motor with a pressure sensor, sensing the pressure in the part of the flexible tube behind the pressure rollers. With such a function the motor may work as a servomotor, wherein the pressure in the flexible tube determines the motor speed forward. This entails that the pressure in the flexible tube does not need to be very high, which saves on energy and reduces wear on the consisting parts.

The flexible tube cleanser may also be used when a new type of smoothing compound is to be used. When all smoothing compound of the first type has been fed out by the outlet pump, the flexible tube cleanser is put in an active position close to the outlet nozzle. The other type of smoothing compound is then mixed by the mixer and then fed out by the outlet pump. The amount of smoothing compound of the first type present in the flexible tube will then be fed out of the flexible tube by the other type of smoothing compound being fed into the flexible tube and pressing the pressure rollers of the flexible tube cleanser forward along the flexible tube. The two types of smoothing compound are thus kept completely separated from one another, which minimizes the loss.

The feeder unit 3 comprises a powder transporter 22, which sucks in smoothing compound powder from a first powder tank 23 and blows the smoothing compound powder through the flexible powder tube 17 to the receiver part 5 of the mixing unit. The feeder unit may further be provided with a valve 26, which is connected to several powder tanks, the first tank 23, a second tank 24 and a third tank 25. The valve can connect any one of the tanks to the powder transporter. In this way a user may choose the desired type of smoothing compound at the input device of the control unit, whereby the valve connects the correct powder tank, so that the correct smoothing compound powder can be fed to the mixing unit. When only one type of smoothing compound is used, the valve and the other tanks are of course unnecessary. A return tank also may be placed at the feeder unit, if needed. The powder transporter 22 and the valve 26 are advantageously controlled from the control unit 10 of the mixing unit.

The feeder unit is advantageously provided with wheels to be easily transportable. For instance, the feeder unit may be a transporting trailer with mounted equipment. There is suitably also room for the mixing unit and the flexible tube bundle on the trailer. The smoothing compound powder is transported in bulk in the powder tank. This makes it simple to fill smoothing compound powder, as the entire feeder unit can be taken to a depot for filling of smoothing compound powder. The handling of smoothing compound powder is thus simplified.

When smoothing compound is to be mixed at a building area of some kind, the feeder unit is taken to a suitable place in the vicinity of the area to be smoothed. It is advantageous if the flexible tube length can be kept relatively short. A flexible tube length shorter than 50 metres is preferable, partly considering the dimensions of the feeder equipment, partly considering the handling of the flexible tube bundle. The mixing unit is carried by the user to the area to be smoothed, and the flexible tube bundle is connected between the feeder unit and the mixing unit.

The user then chooses a suitable smoothing compound program on the input device. The chosen amount of smoothing compound will now be mixed automatically and be fed out in e.g. a bucket or a flexible tube. The user may then apply the smoothing compound in the intended area. When e.g. a floor is treated with liquid smoothing compound a suitable amount of smoothing compound can be chosen, which may be mixed and fed out continuously. It is also possible to choose an amount of smoothing compound per time unit, whereby a suitable amount of smoothing compound is fed out continuously, adapted to the users' smoothing method and smoothing rate. When the mixing is continuous it is possible to connect a flexible tube to the smoothing compound outlet, which simplifies the spreading of the smoothing compound.

When one area is smoothed, the mixing unit may be carried by the user to the next area to be smoothed. If another smoothing treatment is to be done within a shorter time interval, the mixing unit does not need to be cleaned. Otherwise the mixing unit is set to a cleaning mode, in which only water is fed into the mixer, washing smoothing compound residues away from the mixer.

The advantage of a mixing unit and a mixing device according to the invention is that a better work environment is achieved for the workers handling the smoothing compound. Heavy lifting can be minimized, because the mixing unit is light enough to be easily carried by one person, the work environment is improved, because the powder is handled in a closed system, and the losses are also minimized, because it is possible to mix a predetermined amount of smoothing compound. A more uniform quality is also attained, because the smoothing compound is mixed in the same way every time. The mixing time can also be minimized.

The invention is not limited to the embodiment described, but rather a number of further variants and modifications are possible within the frame of the following claims.

### LIST OF REFERENCE NUMBERS

1: Mixing device

2: Mixing unit

3: Feeder unit

4: Flexible tube bundle

5: Receiver part

6: Dosing equipment for powder

7: Dosing equipment for water

8: Mixer

9: Outlet pump

10: Control unit

11: Scale

12: Funnel

13: Powder inlet

14: Water inlet

15: Smoothing compound outlet

17: Flexible powder tube

18: Flexible water tube

20: Electrical cable

21: Control cable

22: Powder transporter

23: First tank

24: Second tank

25: Third tank

26: Valve

28: Additive tank

29: Additive doser

30: Feeder unit

31: Mixer motor

32: Pump motor

33: Mixer screw

34: Outlet screw

35: Outlet shaft

36: Mixer housing

37: Strut

38: Central axis

51: Flexible tube cleanser

52: Flexible smoothing compound tube

53: Steering pipe

54: Lead-in flange

55: Pressure roller

56: Arm

57: Feeding direction

1. A mixing unit for mixing of a cement product, wherein the mixing unit is carryable, comprising:
a mixer for the mixing of powder and water, and
an outlet pump for feeding out the finished mixed cement product,
wherein the mixing unit comprises a receiver part for powder, dosing equipment for powder and dosing equipment for water.

2. The mixing unit according to claim 1, wherein the mixing unit weighs less than 32 kg.

3. The mixing unit according to claim 2, wherein the mixing unit weighs less than 25 kg.

4. The mixing unit according to claim 3, wherein the mixing unit weighs less than 20 kg.

5. The mixing unit according to claim 1, in that wherein the mixing unit further comprises an electronic control unit that controls the mixing of the cement product.

6. The mixing unit according to claim 1, wherein the mixer comprises an open mixer screw with a spiral screw without a central shaft.

7. The mixing unit according to claim 6, wherein the mixer housing is made of a flexible material.

8. The mixing unit according to claim 1, wherein the mixer and the outlet pump are arranged along the same central axis.

9. The mixing unit according to claim 8, wherein the mixer is operated by a first motor and the outlet pump is operated by a second motor.

10. The mixing unit according to claim 1, wherein the mixing unit further comprises a flexible tube cleanser which moves along a flexible outlet tube connected to the smoothing compound outlet of the mixing unit, and the flexible tube cleanser comprises two pressure rollers to press the flexible tube together.

11. The mixing unit according to claim 10, wherein the flexible tube cleanser driven along the flexible tube by way of a pressure applied from the smoothing compound outlet.

12. A mixing device (1) for handling of a cement product, comprising the mixing unit according to claim 1, wherein the mixing device further comprises a feeder unit to feed in powder to the mixing unit and a flexible tube bundle connecting the mixing unit to the feeder unit.

13. The mixing device according to claim 12, wherein the feeder unit comprises a powder transporter and at least one powder tank.

14. A method for mixing a cement product with a mixing device according to claim 12, comprising the steps of
feeding powder from a powder tank in a feeder unit to a receiver unit through a flexible tube,
dosing powder from the receiver unit with dosing equipment to a mixer,
simultaneously dosing water to the mixer with dosing equipment,
mixing the powder and the water with a mixer,
feeding the finished mixed cement product out with an outlet device.

15. Method according to claim 14, wherein the method comprises the step of automatic cleaning of the mixer at a predetermined time.
